(19) United States
(12) Patent Application Publication
(10) Pub. No.: US 2019/0388932 A1
(43) Pub. Date: Dec. 26, 2019

(54) METHOD FOR PRODUCING A PLASTIC COMPONENT, AS WELL AS PLASTIC COMPONENT AND PROCESSING INSTALLATION

(71) Applicant: Magna Exteriors GmbH, Sailauf (DE)

(72) Inventor: Marc HUTTENLOCHER, Nuertingen (DE)

(21) Appl. No.: 16/437,175

(22) Filed: Jun. 11, 2019

(30) Foreign Application Priority Data
Jun. 22, 2018 (DE) 10 2018 210 215.5

(51) Int. Cl. B05D 1/02; B05D 1/32; B29C 65/48; B29C 65/00; B62D 65/00

(52) U.S. Cl. CPC B05D 1/02; B05D 1/32; B29L 2031/30; B29C 66/87; B62D 65/00; B29C 65/48

(57) ABSTRACT

A description is given of a method for producing plastic components for a vehicle, wherein the plastic components are at least partially painted in a painting step and then connected on the non-painted areas to further components, wherein at least one region, which is used for connecting to the further components, is masked by a preceding application process of applying a sealing, detachable polymer.

### CROSS-REFERENCE TO RELATED APPLICATIONS

This application claims the benefit and priority of German Patent Application No. 10 2018 210 215.5, filed Jun. 22, 2018. The entire disclosure of the above application is incorporated herein by reference.

### FIELD

The present invention is based on a method for producing plastic components, preferably for a vehicle, wherein the plastic components are at least partially painted in a painting step and then connected on the non-painted areas to further components.

The invention extends to a plastic component that is produced by the method.

Furthermore, the invention relates to a processing installation with which the method can be performed.

### BACKGROUND

This section provides background information related to the present disclosure which is not necessarily prior art.

In automobile construction, large-format plastic components or plastic assemblies have been used for some time. For the body, this includes producing front or rear modules from plastic, as well as doors or tailgates or else trim parts for door sills or pillars of the vehicle, painted interior trim, roof modules, etc.

Depending on the intended purpose of the large-format plastic components or plastic assemblies, the plastic components are connected to further components for strengthening or for covering or for receiving functional components.

EP 2 384 917 B1 discloses such a vehicle body assembly in which regions for fastening are provided, and wherein the component is made up of multiple individual structures.

When the plastic components are used for the body of the vehicle, they are generally painted in the colour of the car. The painting takes place directly after the component has been produced by plastic injection moulding. The components, which are often of a large format, are painted by using painting lines, in which arms of robots hold the plastic component, with or without a frame, while it is sprayed with paint.

When doing so, it is unavoidable that not only the visible surfaces that are actually intended to be painted are provided with paint but also rear sides or covered areas are contaminated with so-called “overspray”. This is the paint spray deposited over the component as a whole.

Since the plastic components still have to be fitted and processed after painting, this contamination caused by the painting is detrimental. Especially when processing the plastic components by means of joining processes such as welding or adhesive bonding, the remains of paint interfere with reliable processing. In order to keep regions on the plastic components free from contaminants after painting, during production adhesive strips, known as masking aids, are stuck onto the regions that are ultimately required for further processing of the plastic component, or they are protected by masking moulds that are on the frame, lying close to the component.

This masking process usually has to be carried out manually, and the removal of the adhesive strips after painting is also performed manually. The adhesive strips are then not to be used again, and indeed cannot be used again.

The adhesive strip method cannot provide continuous contours, since for example radii have to be created by applying multiple pieces of adhesive strip.

On the basis of this prior art, the object of the invention is to present a method for producing plastic components which are painted, wherein regions are masked in an easy way. The object of the invention is also to produce a plastic component which is prepared particularly easily and inexpensively for further processing, and is also environmentally compatible.

For this purpose, a processing installation is used.

### SUMMARY

This section provides a general summary of the disclosure, and is not a comprehensive disclosure of its full scope or all of its features.

The object is achieved by a method for producing component systems, wherein components are, in a first step, at least partially painted or coated and then connected on the non-painted or coated areas to further components, wherein at least one region, which is used for connecting to the further components, is masked by a preceding application process of applying a sealing, detachable polymer.

Specifically, the object is achieved by a method for producing plastic components, preferably for a vehicle, wherein the plastic components are at least partially painted in a painting step and then connected on the non-painted areas to further components, wherein at least one region, which is used for connecting to the further components, is masked by a preceding application process of applying a sealing, detachable polymer.

Advantageously, at least the front side of the plastic component is painted and contamination caused by overspray is avoided on the inner side by covering with the polymer.

It is of advantage that the application process is performed by a robot along given contours and given regions.

It is of advantage here that, after the processing step, in a further combining step the plastic component is connected to further components of plastic and/or of metal and/or of composite material in the regions for connection.

Advantageously, the regions for connection are adhesively attached, wherein in an advantageous embodiment the same polymer is used for connection as for covering the regions. Moreover, the robot arm may cover with polymer the same contour or the same regions as are used in the adhesive bonding.

The object is also achieved by plastic components produced by the method, wherein the plastic components are tailgates, or front modules or rear modules or door sill trim, roof modules or front aprons of a vehicle.

The object is also achieved by a processing installation, which may include stations including at least one station for covering regions with polymer.

It is of advantage that the processing installation includes a station for machining with stamping and/or drilling tools.

It is also advantageous if there is a station for the adhesive bonding of components. However, the stations do not have to be separate from one another.

It is therefore of advantage that the application process and the combination process are performed on the same processing station, using the same robot. One dispensing system may be used for the adhesive bonding and for the masking, but there may also be two separate dispensing systems.

Possibly also the same polymer is used.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is explained in the following exposition and is represented by figures.

FIG. 1 shows an example of a vehicle tailgate;

FIG. 2 schematically shows production steps; and

FIG. 3 schematically shows a processing station.

Corresponding reference numerals indicate corresponding parts throughout the several views of the drawings.

### DETAILED DESCRIPTION

Example embodiments will now be described more fully with reference to the accompanying drawings.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The method according to the invention is represented by way of example on a plastic component 4, wherein the method can also be applied to components 40 that consist of other materials.

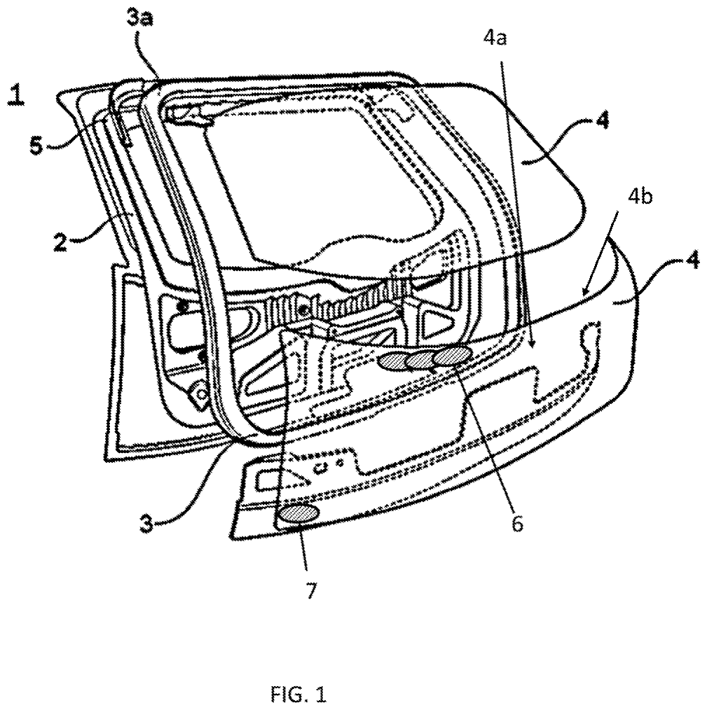

FIG. 1 shows the main component parts of a tailgate 1, which is used as an example of large-area plastic components as trim parts. Serving as a base of the tailgate is a support part 2, which is produced for example from fibre-reinforced plastics. The stiffening frame 3 is a closed shape or else a non-closed shape of any kind of a polyurethane material or other composite materials. The plastic components 4 are connected to the support part 2. Stiffening elements 5, which in this exemplary embodiment are produced from metal and are arranged in the region 3a, are provided for stiffening the tailgate. They are separately connected to the support part 2.

As trim parts, the plastic components 4 are in this case painted on their visible areas 4a. The painting may in this case also include of course regions of the periphery of the plastic components 4 that remain visible after assembly.

On the inner side 4b of the plastic components 4 there are regions 6 which have to be freed of contaminants for the connection of the plastic component 4 to the support part 2.

Furthermore, the plastic component 4 may also have regions 7 which have to be prepared for receiving sensors and likewise have to be freed of contaminants.

The plastic components 4 on the tailgate are cited by way of example for the plastic components that are mounted on the vehicle with externally visible painted areas.

The regions 6 have previously been covered manually with adhesive strips. Particularly in the case of complicated contours, the effort involved is not inconsiderable. Once the components 4 have been painted, the adhesive strips are removed again manually.

The solution according to the invention envisages covering the regions 6 to be protected from contamination with paint spray with a polymer. The polymer may in this case be the adhesive which in a later method step connects components to one another. It is intended that the polymer can be easily applied and, as a closed film, can also be detached again in an easy way.

Used for example for this is RAKU-PUR® 32-3250/RAKU PUR 32-3278-, a polyurethane-based thixotropic two-component system. It consists of a filled component A and an isocyanate curing agent B. The system does not contain any solvent or plasticizer, it is consequently also conceivable for materials susceptible to stress cracking or for applications with restricted emissions (odour, gas emissions).

This material displays the properties that are important for use as a covering polymer structure. It displays a high tear resistance, which is important when detaching the polymer structure. A certain height of the material, which can be adjusted when it is applied, makes its removal much easier than the removal of an adhesive tape. The material can also be set with short bonding times, which is important if the polymer is also used as an adhesive.

The use of the same material for covering and adhesively attaching components is an optimum solution, since only one processing station and/or one robot has to be used for this. Moreover, the contours or regions 6 for covering are identical to the contours or regions for adhesive bonding. Thus, the control, once set, can use the robot arm both for the covering and for the adhesive bonding. The masking material must possibly be made a little more liquid, in order that a wider coverage is obtained, while the adhesive bead is compressed by the joining of the components. At the same time, it must be noted that the adhesive must stick, whereas the masking must allow itself to be detached again.

The example is chosen from automobile construction, but can also be used for other media that are painted, for example hybrid/composite components, metal components.

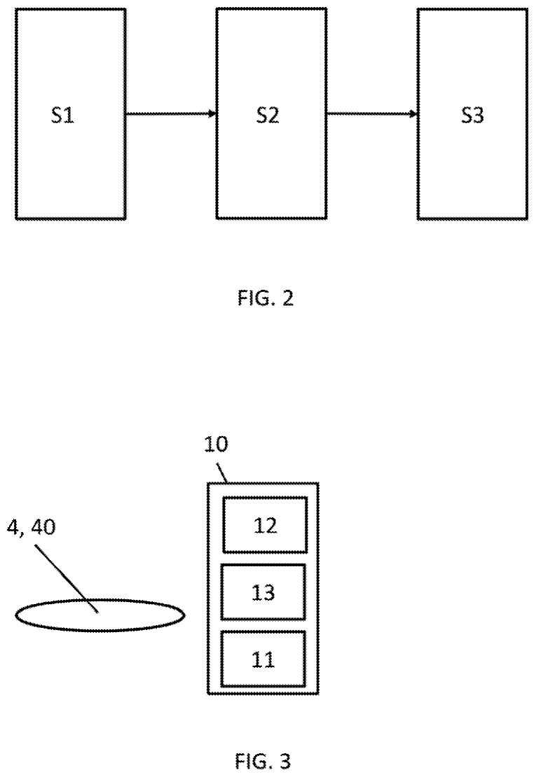

FIG. 2 schematically shows the processing method in the three main steps. It is not intended here that the processing method is limited to these three main steps.

In a first processing step S1, the plastic component 4—representative of all components 40—is provided with the covering polymer. For this purpose, the plastic component 4 is processed in a processing station, in that a robot arm applies a bead of the polymer material. In this case, curved, three-dimensional contours should be processed with a strand of bead and are applied in a continuous path.

For example, a circular path may be drawn around a fastening element.

Then, the plastic component 4 is transferred to the second processing station. The bead may be as wide as an adhesive bead, or advantageously wider, which is brought about by a more liquid mixture or by using another mixture from a second dispensing system.

The components are usually cleaned before painting. So-called power-wash systems are used for example for this. In this case, the masking must of course withstand being transported and exposed to the power-wash system.

In the second processing step, the painting step S2, or in a second processing station, the plastic components 4, for example the trim parts, are painted. In this case, the plastic components 4 are processed in different orientations. Particularly when using painting robots and robot arms, which guide the components with or without frames, the plastic components 4 are held, and thus painted, in a wide variety of orientations.

For their further processing and joining together to form a complete component, the painted plastic components now have to be freed of the polymer contaminated with paint spray. For this purpose, the polymer bead is removed, either manually or by being pulled off by a robot.

It is advantageous if the masking material binds the paint and ensures a clean, particle-free tearoff edge. Polyurethane systems can do this.

With a polyurethane system, the pulled-off masking bead can be used again unproblematically and cost-effectively, which with a masking adhesive tape is scarcely conceivable in terms of cost-effectiveness and does not happen in production.

It should also be emphasized moreover that, when masking, there must not be any remains left behind for the further adhesive attachment process.

In the processing step S3, the processing installation 10 takes over the painted plastic component 4 automatically or manually and it includes at least one processing station 13, in which the plastic component 4 is adhesively bonded to further components.

What is meant here by further components is components of the same material as the components 40, or of a different material, and also functional components such as sensors, or connectors or locks, etc.

In the next processing step S3, the prepared plastic component 4 is connected to further elements and further components.

FIG. 3 likewise schematically shows the processing installation 10. The processing installation 10 has in this case a station 11 for covering regions 6, 7.

Furthermore, the processing installation 10 may include a station 12 for machining with stamping and/or drilling tools.

In the exemplary embodiment, the processing installation 10 also includes a station 13, which is designed for the adhesive attachment of components.

The two stations 11 and 13, which both operate using one robot arm, may also be designed as a common station. Such a solution is particularly advantageous, since the robot can provide both the covering and the adhesive bonding with the same material.

The method according to the invention may be used for any painting or for any medium to be painted, in which respect the material of the masking has to be modified to the respective medium.

For example, the masking may also be performed by means of other material systems, such as for example silicone, although with the existing, classic painting operations silicone is usually disadvantageous.

The masking is also used in other coating applications, for example powder coating or even electrodeposition.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### DESIGNATIONS

1 Component

2 Support part

3 Frame

3a Region of the frame

4 Plastic component

4a Visible area

4b Inner side

5 Reinforcing part

6 Regions for connection

7 Regions for functions

S1, S2, S3 Processing steps

10 Processing installation

11 Station for covering

12 Station for machining

13 Station for adhesive bonding

40 Components

What is claimed is:

1. A method for producing component systems, wherein components have at least one region, which is used for connecting to the further components, wherein the at least one region is masked by a preceding application process of applying a sealing, detachable polymer, and in a processing step the components are at least partially painted or coated and then connected on non-painted or coated areas, which correspond to the masked regions, to the further components.

2. The method for producing components according to claim 1, wherein the components consist of plastic or metal or a composite material.

3. The method according to claim 1, wherein the front side of the component is painted and contamination caused by overspray is avoided on the inner side by covering with the polymer.

4. The method according to claim 1, wherein the application process is performed by a robot along given contours and given regions.

5. The method according to claim 1, wherein after the processing step, in a combination process, the plastic component is connected to further components of plastic and/or of metal and/or of composite material in the regions for connection.

6. The method according to claim 1, wherein the regions for connection are adhesively attached.

7. The method according to claim 1, wherein the application process and the combination process are performed on the same processing station, using the same robot.

8. A component produced by the method according to claim 1, wherein the plastic components are tailgates, or front modules or rear modules or door sill trim, roof modules or front aprons of a vehicle.

9. A processing installation for a plastic component or component produced by a method according to claim 1, wherein the processing installation comprises at least one station for covering regions with polymer.

10. The processing installation for a plastic component according to claim 9, wherein the processing installation includes a station for machining with stamping and/or drilling tools.

11. The processing installation for a plastic component according to claim 9, wherein there is a station for the adhesive bonding of components.

12. The processing installation for a plastic component according to claim 9, wherein the station for the adhesive bonding and the station for the covering are the same.

13. The processing installation for a plastic component according to claim 9, wherein the same polymer is used for connection as for covering.
